(19) United States
(12) Patent Application Publication
(10) Pub. No.: US 2026/0100633 A1
(43) Pub. Date: Apr. 9, 2026

(54) CONVERTING DEVICE AND CONTROLLING METHOD THEREOF

(71) Applicant: AcLeap Power Inc., Taipei City (TW)

(72) Inventors: Rui Wu, Shanghai City (CN); Tom Sun, Shanghai City (CN); Rihua Liao, Shanghai City (CN)

(21) Appl. No.: 19/020,122

(22) Filed: Jan. 14, 2025

(30) Foreign Application Priority Data
Oct. 8, 2024 (CN) 202411393156.0

(51) Int. Cl. H02M 1/00; H02M 3/335

(52) U.S. Cl. CPC H02M 1/0058; H02M 3/33569

(57) ABSTRACT

A method of controlling a converting device is disclosed. The method comprises turning on a first switch coupled to a primary coil and a second switch coupled to the primary coil to generate a primary current flowing through the primary coil; generating a secondary current flowing through a secondary coil according to the primary current, and powering a load by the secondary current; when each of the first switch and the second switch is turned off, turning on a third switch coupled to the primary coil and a fourth switch coupled to the primary coil; when the third switch is turned off, discharging a capacitor of the second switch to the primary coil, and reducing a voltage difference of two terminals of the second switch to a zero voltage level; and turning on the second switch when the voltage difference of the two terminals of the second switch has the zero voltage level.

### CROSS-REFERENCE TO RELATED APPLICATIONS

This application claims priority to Chinese Patent Application No. 202411393156.0, filed Oct. 8, 2024 and titled “CONVERTING DEVICE AND CONTROLLING METHOD THEREOF”, the contents of which are hereby incorporated by reference in its entirety.

### BACKGROUND

The design of an electronic device having high power, high frequency, and high power density has become a trend in the industry. The circuit design and controlling method of a common converting device has the feature of hard-switch, which limits the converting frequency and power density of the converting device. In order to overcome this issue, the design of a circuit and its controlling method having the feature of soft-switch is necessary, so that the feature of Zero Voltage Switch (ZVS) can be achieved.

In some circumstances, LLC circuit can achieve ZVS; however, the range of the input and output voltage is relatively narrow. In some other circumstances, phase-shifted full-bridge converter can also achieve ZVS; however, the circuit of the converter requires additional inductors to be implemented, which further increase the total power consumption and the voltage stress of the synchronous rectifier.

In order to overcome the issues mentioned above while achieving ZVS, it is necessary to employ a novel controlling method to achieve ZVS without implementing additional electronic components as well as achieve the effect of high power, high frequency, and high power density.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a circuit diagram illustrating a converting device according to some embodiments of the disclosure.

FIG. 2 is a timing diagram illustrating the control of a converting device according to some embodiments of the disclosure.

FIG. 3A is a circuit diagram illustrating a converting device according to some embodiments of the disclosure.

FIG. 3B is a circuit diagram illustrating a converting device according to some embodiments of the disclosure.

FIG. 3C is a circuit diagram illustrating a converting device according to some embodiments of the disclosure.

FIG. 3D is a circuit diagram illustrating a converting device according to some embodiments of the disclosure.

FIG. 3E is a schematic diagram illustrating the operation of a converting device according to some embodiments of the disclosure.

FIG. 3F is a schematic diagram illustrating the operation of a converting device according to some embodiments of the disclosure.

FIG. 3G is a schematic diagram illustrating the operation of a converting device according to some embodiments of the disclosure.

FIG. 4 is a flow chart diagram illustrating the method of controlling a converting device according to some embodiments of the disclosure.

### DETAILED DESCRIPTION

The following disclosure provides different embodiments, or examples, for implementing features of the provided subject matter. Specific examples of components, materials, values, steps, arrangements, or the like, are described below to simplify the present disclosure. These are, of course, merely examples and are not limiting. Other components, materials, values, steps, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for case of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The following disclosure provides a method of operating a power system, the power system includes a power generator and remote transfer switch, which can be applied to a continuous control technique of power supply, providing electricity continuously to multiple loads, and extending the time of power supplied. When the utility power system is abnormal, an energy storage system of the power system is switched from current source mode to voltage source mode to support the voltage and the frequency of the bus in the power system, and provide power to other power supply system and loads on the bus. When the state of charge of the energy storage system is insufficient, the energy storage system is no longer able to support the power and voltage stability of the power system, and thus it is required to cut-off (off load) the loads stage by stage. The following disclosure combines the power generator and remote transfer switch technique to promote the power supplying control technique of the power system. In some embodiment, the power system can be embodied by a microgrid system.

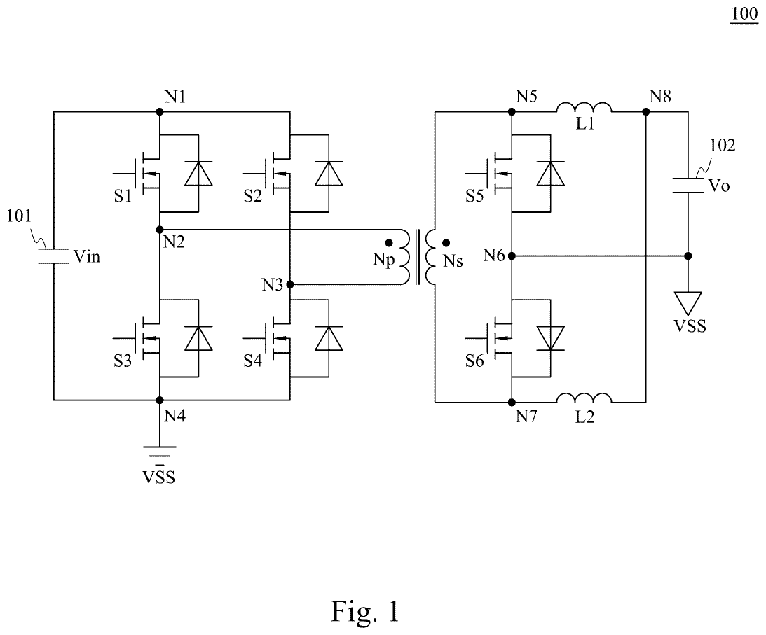

FIG. 1 is a circuit diagram illustrating a converting device 100 according to some embodiments of the disclosure. As shown in FIG. 1, the converting device includes an input power source 101, an output load 102, multiple switches S1-S6, an inductor L1, an inductor L2, a primary coil Np, and secondary coil Ns.

In some embodiments, the switched S1-S6 can be implemented by Metal Oxide Semiconductor Field-Effect Transistor (MOSFET). In some embodiments of the disclosure, the switches S1-S6 can be implemented by N-type MOSFET. The converting device 100 is a full-bridge convertor circuit including the switches S1-S6, the primary coil Np, and the secondary coil Ns. In some embodiments, the switches S5 and S6 can be implemented as current multiplier, configured to synchronously rectifies the converting device 100.

In some embodiments, the input power source 101 is configured to provide an input voltage Vin. The converting device 100 is configured to provide an output voltage Vo to the load 102 based on the input voltage Vin. When the converting device is operating, two terminals of the primary coil has a primary voltage difference Vp, and two terminals of the secondary coil Ns has a secondary voltage difference Vs.

As shown in FIG. 1, the drain terminal of the switch S1 is coupled to the positive terminal of the input power source 101 at a node N1 to receive the input voltage Vin. The source terminal of the switch S1 is coupled to a dotted terminal of the primary coil Np at a node N2. The drain terminal of the switch S2 is coupled the node N1, and the source terminal of the switch S2 is coupled to a non-dotted terminal of the primary coil Np at a node N3. The drain terminal of the switch S3 is coupled the node N2, and the source terminal of the switch S3 is coupled to a node N4. The drain terminal of the switch S4 is coupled to the node N3, and the source terminal of the switch S4 is coupled to the node N4. Wherein the node N4 is configured to receive a reference voltage signal Vss, and the node N4 is coupled to the negative terminal of the input power source 101. In some embodiments, the reference voltage signal Vss has a grounded voltage level, wherein the grounded voltage level is lower than a voltage level of the input voltage Vin.

In some embodiment, the drain terminal of the switch S5 is coupled to a node N5, and the source terminal of the switch S5 is coupled to a node N6. The drain terminal of the switch S6 is coupled to a node N6, and the source terminal of the switch S6 is coupled to a node N7. A dotted terminal of the secondary coil Ns is coupled to the node N5, and a non-dotted terminal of the secondary coil Ns is coupled to the node N7. The dotted terminal of the secondary coil Ns is further coupled to a terminal of the inductor L1 at the node N5. The other terminal of the inductor is coupled to the output load 102 at a node N9 to transmit the output voltage Vo. The non-dotted terminal of the secondary coil is further coupled to a terminal of the inductor L2 at the node N7. The other terminal of the inductor L2 is coupled to the node N8. Wherein the node N6 is further configured to receive the reference voltage signal Vss.

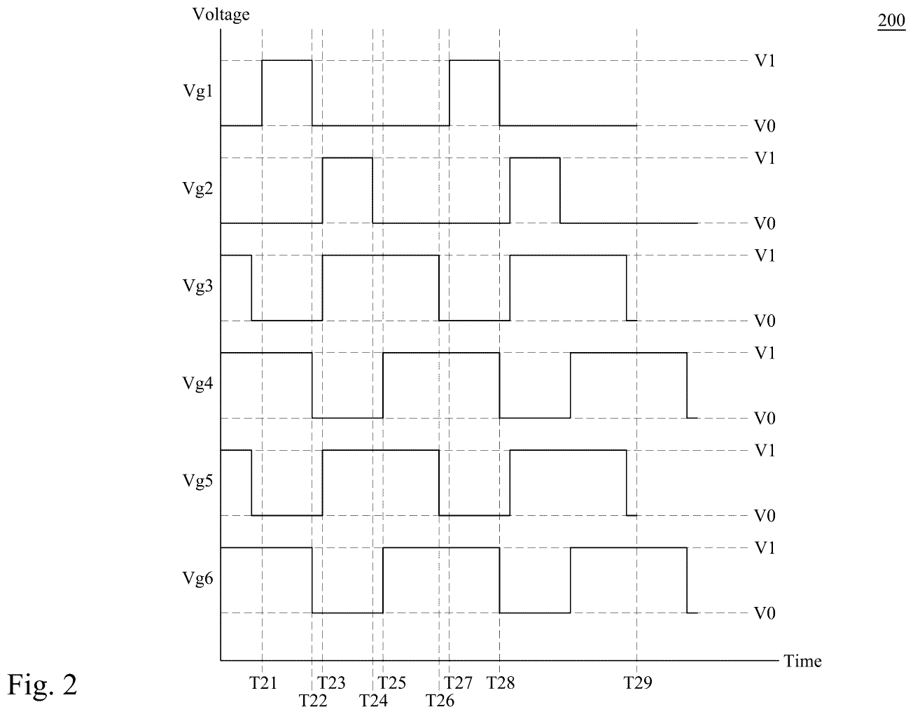

The disclosure provides a non-symmetric controlling method to control the turning on and off of the switches S1-S4. The non-symmetric controlling method is able to achieve the Zero Voltage Switch (ZVS) by individually controlling the turning on and off of the switches S1-S4. The specific implementations and the controlling method thereof will further be discussed in details from FIG. 2 to FIG. 4 and corresponding paragraph of the disclosure.

FIG. 2 is a timing diagram illustrating the control of a converting device 100 according to some embodiments of the disclosure. As shown in FIG. 2, the timing diagram 200 illustrates the operation of the converting device 100 in the period from time T21 to T29.

Referring to FIG. 1 and FIG. 2, the timing diagram 200 illustrates the change with respect to time of multiple voltage control signals Vg1-Vg6 which are configured to control the turning on and turning off of the switches S1-S6. The gate terminals of the switches S1-S6 are configured to receive the voltage control signal Vg1-Vg6 respectively. In some embodiments, in response to one or more of the voltage control signals Vg1-Vg6 having a voltage level V0, the corresponding one or more of the switches is turned off.

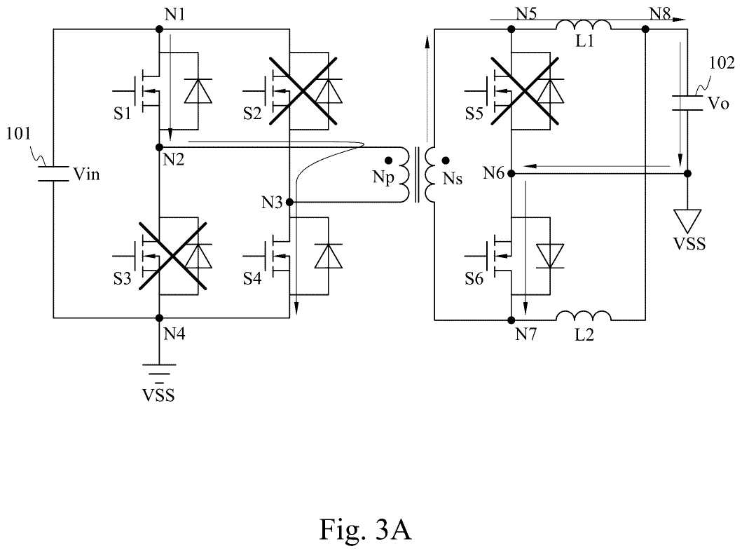

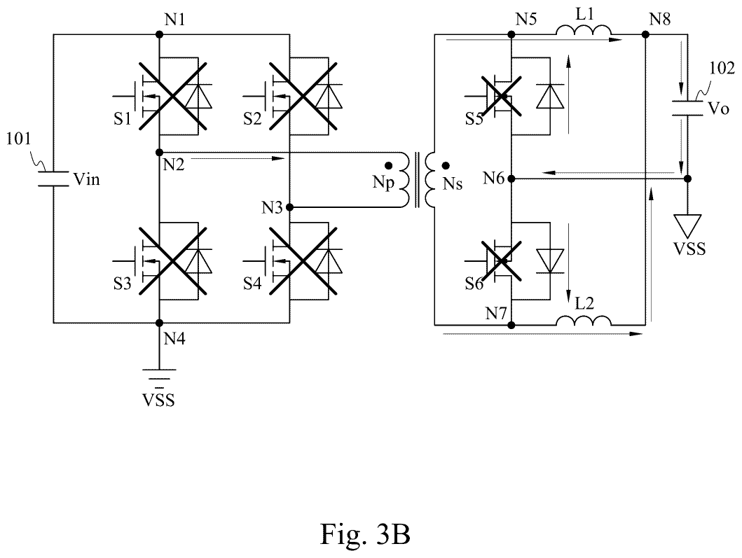

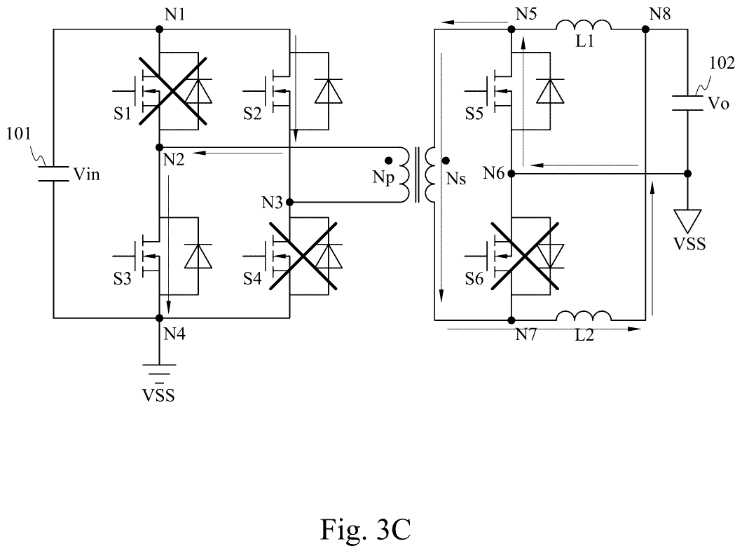

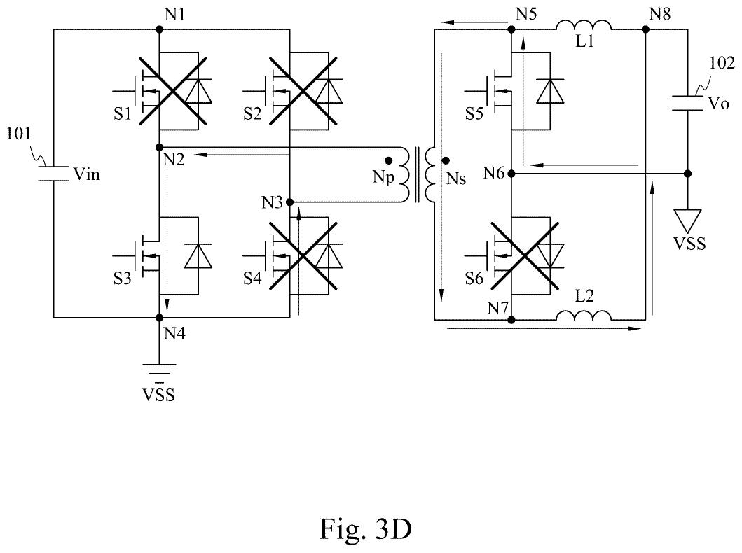

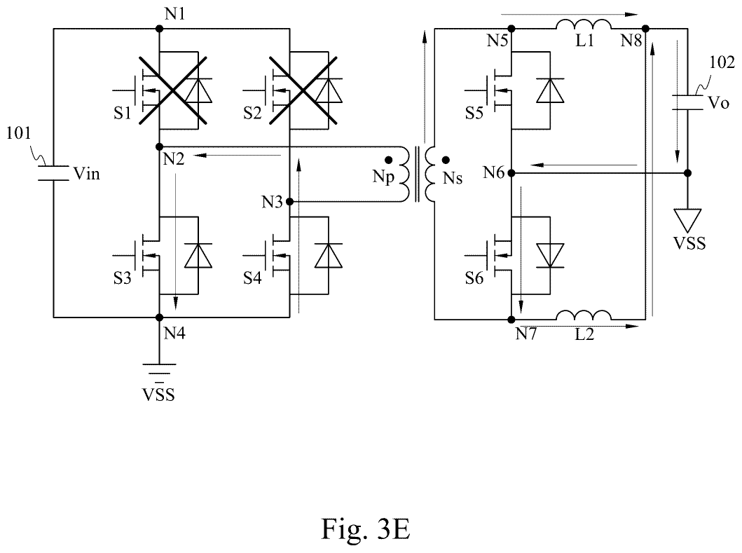

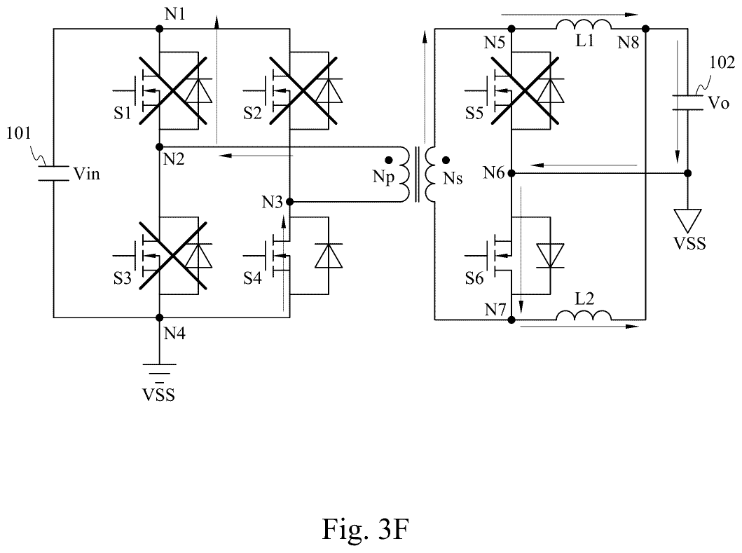

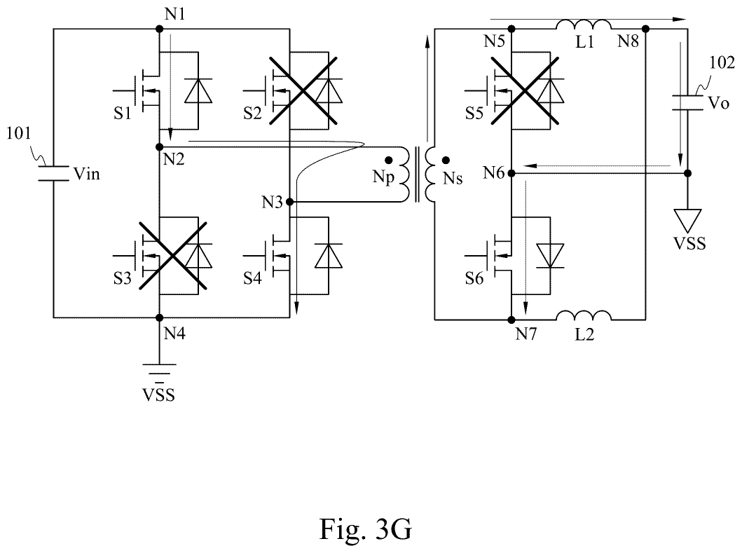

FIGS. 3A-3G are circuit diagrams illustrating the operation of a converting device 100 during different periods in the timing diagram 200 shown in FIG. 2 according to some embodiments of the disclosure. FIG. 3A corresponds to a period between time T21 and T22. FIG. 3B corresponds to a period between time T22 and T23. FIG. 3C corresponds to a period between time T23 and T24. FIG. 3D corresponds to a period between time T24 and T25. FIG. 3E corresponds to a period between time T25 and T26. FIG. 3F corresponds to a period between time T26 and T27. FIG. 3G corresponds to a period between time T27 and T2.

Referring to FIG. 2 and FIG. 3A, in the period between time T21 and T22, each of the voltage control signals Vg1, Vg4 and Vg6 has a voltage level V1, so that the switches S1, S4, and S6 remain turned on. Each of the voltage control signals Vg2, Vg3, and Vg5 has the voltage level V0, so that the switches S2, S3, and S5 remain turned off.

In the period between time T21 and T22, the input power source is configured to provides the input voltage Vin to the drain terminal of the switch S1 to generate a current ip, so that the node N1 has a voltage level being the same as the input voltage Vin. The primary current Ip flows through the switch S1 so that the two source/drain terminals has a voltage difference Vs1. The primary current Ip flows through the switch S1, and further flows from the dotted terminal of the primary coil Np through the primary coil Np to the switch S4 to form a loop with the input power source 101.

In some embodiments, when the primary current Ip flows through the switch S4, the two source/drain terminals of the switch S4 has a voltage difference Vs4, and the secondary coil Ns generates a secondary current Is that flows out from the dotted terminal of the secondary coil Ns. The secondary current Is flows through the inductor L1 to the output load 102 to generate the output voltage Vo, and the secondary current Is further flows from the node N6 to the output load 102, and then flows through the switch S6 to the non-dotted terminal of the secondary coil Ns to form a loop. In response to the secondary current Is flows through the switch S6, the two source/drain terminals of the switch S6 has a voltage difference Vs6.

At this moment, the dotted terminal of the primary coil Np is an anode and the non-dotted terminal of the primary coil Np is a cathode. The dotted terminal of the secondary coil Ns is a cathode and the non-dotted terminal of the secondary coil Ns is an anode.

In some embodiments, the primary current Ip includes a current that generated by the input voltage Vin supplied to the switch S1 or the switch S2, and a leakage current generated by the primary current Ip flowed through each of the switches S1-S4. The primary current Ip flows from the dotted terminal of the primary coil Np to the primary coil Np, so that the dotted terminal of the primary coil Np has a positive voltage and the non-dotted terminal has a negative voltage. In response to the primary current Ip flows through the primary coil Np, two terminals of the primary coil Np has a voltage difference Vp.

In some embodiments, the secondary current Is includes a current generated by a voltage difference of the voltage Vp and the voltage Vs, and an excited current generated by the magnetic induction from the primary coil Np to the secondary coil Ns. The secondary current Is flows from the non-dotted terminal of the secondary coil Ns to the secondary coil Ns, so that the non-dotted terminal of the secondary coil Ns has a positive voltage and the dotted terminal has a negative voltage. In response to the secondary current Is flows through the secondary coil Ns, two terminals of the secondary coil Ns generates a voltage difference Vs which opposite to the voltage difference Vp. In some embodiments, the primary current Ip which flows through the primary coil Np has a flowing direction that is opposite to the secondary current Is which flows through the secondary coil Ns.

In some embodiments, when the switch S1 and/or S4 is turned on, the switch S6 is turned on at the same time, configured to perform synchronously rectification. When the switch S6 is turned on, the secondary current Is flows from the node N6 into the drain terminal of the switch S6, and then flows out from the source terminal of the switch S6 to the node N7.

Then, at time T22, each of the voltage control signals Vg1, Vg4, and Vg6 is switched to the voltage level V0, so that each of the switches S1, S4, and S6 is turned off. When the switches S1 and S4 are turned off, each of a capacitor Coss_S2 of the switch S2 and a capacitor Coss_S3 of the switch S3 starts discharging to the primary coil Np.

At this moment, electric charges flow from the primary coil Np through the secondary coil Ns generating the secondary current Is. The secondary current Is flows through the inductor L1, so that each of the primary voltage difference Vp and the secondary voltage difference Vs starts decreasing. In response to the capacitor Coss_S2 and the capacitor Coss_S3 discharge the primary coil Np, the voltage differences Vs2 and Vs3 start to decrease correspondingly.

Referring to FIG. 2 and FIG. 3B, in the period between time T22 and T23, each of the voltage control signals Vg1-Vg6 has the voltage level V0, so that each of the switches remains turned off.

In the period between time T22 and T23, each of the capacitors Coss_S2 and Coss_S3 keeps discharging to the primary coil Np. In addition, the leakage inductance generated from which the primary current Ip flows from the primary coil Np to the secondary coil Ns further discharging to the capacitors Coss_S2 and Coss_S3. In response to each of the capacitors Coss_S2 and Coss_S3 discharges to the primary coil Np, each of the voltage differences Vs2 and Vs3 keep decreasing to the voltage level V0.

In some embodiments, when the switches S5 and S6 are turned off, each of a body diode of the switch S5 and a body diode of the switch S6 are turned on, and the electric charges discharged by the capacitors Coss_S2 and Coss_S3 respectively flows in a direction from a source terminal to a drain terminal. When each of the body diode of the switch S5 and the body diode of the switch S6 are turned on, the converting device 100 is shorted. In response to the converting device 100 is shorted, each of the primary voltage difference Vp and the secondary voltage difference Vs is decreased to a voltage level 0V, and each of the voltages Vs5 and Vs6 is decreased to a voltage level 0V.

Then, at time T23, each of the primary voltage difference Vp, the secondary voltage difference Vs, the voltage difference Vs2 and the voltage difference Vs3 has a voltage level 0V. Each of the voltage control signals Vg2, Vg3, and Vg5 is switched to the voltage level V1, so that each of the switches S2, S3, and S5 is turned on.

In some embodiments, when each of the switch S1 and S4 is turned off, and each of a voltage level of the voltage Vs2 and a voltage level of the voltage Vs3 is decreased to 0V, the switches S2 and S3 are turned on to perform the ZVS of the switches S2 and S3.

In some circumstances, when the switches S1-S4 are switched from turned-off to turned-on, each of the corresponding voltage differences Vs1, Vs2, Vs3, and Vs4 of the switches S1-S4 is firstly decreased to a voltage level 0V, and then the switches S1-S4 are switched from turned-off to turned-on. These circumstances are called Zero Voltage Switch. When the switches S1-S4 achieve ZVS, stresses generated from each of the voltage differences Vs1, Vs2, Vs3, and Vs4 are decreased, which can further promote the converting efficiency, frequency and power density of the converting device 100.

In some embodiments, when the switches are switching, that is, when the switches S1 and S4 are switched to turned-off and the switched S2 and S3 are switched to turned-on, the stress generated by the voltage differences Vs2 and Vs3 will limit the converting efficiency, frequency and power density of the converting device 100. Relatively, when the switches S2 and S3 are switched to turned-off and the switched S1 and S4 are switched to turned-on, the stress generated by the voltage differences Vs1 and Vs4 will limit the converting efficiency, frequency and power density of the converting device 100.

Referring to FIG. 2 and FIG. 3C, in the period between time T23 and T24, each of the voltage control signals Vg2, Vg3 and Vg5 has the voltage level V1, so that each of the switches S2, S3, and S5 remains turned on. Each of the voltage control signals Vg1, Vg4 and Vg6 has the voltage level V0, so that each of the switches S1, S4, and S6 remains turned off.

In the period between time T23 and T24, the input power source 101 is configured to provide input voltage Vin to the drain terminal of the switch S2 to generate the primary current Ip, so that the node N1 has a voltage level being the same as the input voltage Vin. The primary current Ip flows through the switch S2 so that the two drain/source terminals of the switch S2 has the voltage difference Vs2. The primary current Ip flows through the switch S2, and then flows from the non-dotted terminal of the primary coil Np through the primary coil Np to the switch S3 to form a loop with the input power source 101.

In some embodiments, when the primary current Ip flows through the switch S3, the two drain/source terminals of the switch S3 has the voltage difference Vs3, and the secondary coil Ns generates the secondary current Is which flows out from the non-dotted terminal of the secondary coil Ns. The secondary current Is flows through the indictor Ls to the output load 102 to generate the output voltage Vo, and the secondary current Is flows through the node N6, and flows from the output load 102 through the switch S5 to the dotted terminal of the secondary coil Ns to form a loop. In response to the secondary current Is flows through the switch S5, the two drain/source terminal of the switch S5 has the voltage difference Vs5.

At this moment, the dotted terminal of the primary coil Np is a cathode and the non-dotted terminal of the primary coil Np is an anode. The dotted terminal of the secondary coil Ns is an anode and the non-dotted terminal of the secondary coil Ns is a cathode.

In some embodiments, when the switch S2 and/or S3 is turned on, the switch S5 is turned on at the same time, configured to perform synchronously rectification. When the switch S5 is turned on, the secondary current Is flows from the node N6 into the drain terminal of the switch S5, and then flows out from the source terminal of the switch S5 to the node N5.

Then, at time T24, the voltage control signal Vg2 is switched to the voltage level V0, so that the switch S2 is turned off. When the switch S2 is turned off, the capacitor Coss_S4 of the switch S4 start discharging to the primary coil Np. At this moment, electric charges flow from the primary coil Np through the secondary coil Ns generating the secondary current Is. The secondary current Is flows through the secondary coil Ns to the inductor L2. So that each of the primary voltage difference Vp and the secondary voltage difference Vs starts decreasing. In response to the capacitor Coss_S4 starts discharging to the primary coil Np, the voltage difference Vs4 starts decreasing correspondingly.

Referring to FIG. 2 and FIG. 3D, in the period between time T24 and T25, each of the voltage control signals Vg1, Vg2, Vg4, and Vg6 has the voltage level V0, so that each of the switches S1, S2, S4, and S6 remains turned off. Each of the voltage control signals Vg3 and Vg5 has the voltage level V1, so that each of the switches S3 and S5 remains turned on.

At this moment, the capacitor Coss_S4 keeps discharging to the primary coil Np. In response to the capacitor Coss_S4 keeps discharging to the primary coil Np, the voltage difference Vs4 of two terminals of the switch S4 keeps decreasing to the voltage level 0V.

Then, at time T25, when the voltage difference Vs4 has a voltage level 0V, each of the voltage control signals Vg4 and Vg6 is switched to the voltage level V1, so that each of the switches S4 and S6 is turned on. When the switch S6 is turned on, the secondary current Is flows from each of the switches S5 and S6, which are turned on, to the inductors L1 and L2 respectively, so that the converting device 100 is shorted. In response to the converting device 100 is shorted, each of the primary voltage difference Vp and the secondary voltage difference Vs starts decreasing.

In some embodiments, when the switch S2 remains turned off, and when the voltage difference Vs4 has decreased to a voltage level 0V, the switch S4 is turned on to perform the ZVS of the switch S4.

Referring to FIG. 2 and FIG. 3E, in the period between time T25 and T26, each of the voltage control signals Vg3, Vg4, Vg5, and Vg6 has the voltage level V1, so that each of the switches S3, S4, S5, S6 remains turned on. Each of the voltage control signals Vg1 and Vg2 has the voltage level V0, so that each of the switches S1 and S2 remains turned off.

At this moment, the input power source 101 stops providing the input voltage Vin to the switches S1 and S2. The primary current Ip flows from the switch S4 through the primary coil Np to the switch S3. The node, which is coupled to the source terminal of the switch S3, is configured to receive the reference voltage Vss, so that the primary voltage difference Vp keeps decreasing to a voltage level 0V. When the converting device 100 is shorted, the secondary current Is flows from each of the switches S5 and S6, which are turned on, to the inductors L1 and L2 respectively to supply power to the output load 102, so that the secondary voltage difference Vs keeps decreasing to a voltage level 0V.

Then, at time T26, when each of the voltage differences Vp and Vs has a voltage level 0V, each of the voltage control signals Vg3 and Vg5 is switched to the voltage level V0, so that each of the switches S3 and S5 is turned off. When the switch S3 is turned off, the capacitor Coss_S1 of the switch S1 starts discharging to the primary coil Np. At this moment, electric charges flow from the primary coil Np through the secondary coil Ns and generate the secondary current Is. The secondary current Is flows through the secondary coil Ns to the inductor L1, so that each of the primary voltage difference Vp and the secondary voltage difference Vs starts decreasing. In response to the capacitor Coss_S1 starts discharging to the primary coil Np, the voltage difference Vs1 starts decreasing correspondingly.

Referring to FIG. 2 and FIG. 3F, in the period between time T26 and T27, each of the voltage control signals Vg4 and Vg6 has the voltage level V1, so that each of the switches S4 and S6 remains turned on. Each of the voltage control signals Vg1, Vg2, Vg3, and Vg5 has the voltage level V0, so that each of the switches S1, S2, S3, and S5 remains turned off.

At this moment, the capacitor Coss_S1 keeps discharging to the primary coil Np. In response to the capacitor Coss_S1 keeps discharging to the primary coil Np, the voltage difference Vs1 of two terminals of the switch S1 keeps decreasing to a voltage level 0V.

At time T27, when the voltage level Vs1 has a voltage level 0V, the voltage control signal Vg1 is switched to the voltage level V1, so that the switch S1 is turned on.

In some embodiments, when the switch S3 remains turned off, and a voltage level of the voltage difference Vs1 has decreased to a voltage level 0V, the switch S1 is turned on to perform the ZVS of the switch S1.

In the period between time T27 and T28, each of the voltage control signals Vg1, Vg4, and Vg6 has the voltage level V1, so that each of the switches S1, S4, and S6 remains turned on. Each of the voltage control signals Vg2, Vg3, and Vg5 has the voltage level V0, so that each of the switches S2, S3, and S5 remains turned off.

In some embodiments, the operation of the converting device 100 in the period between time T27 and T28 is similar to the circuit diagram of operating the converting device 100 in FIG. 3A, and the specific implementation can be referred to FIG. 3A and the corresponding paragraph of the disclosure.

In some embodiments, the duration between time T21 and T27 is a half period cycle. The operations of the switches S1-S6 of the converting device 100 during the period that is different to the duration between time T21 and T27 is similar to the operations in the duration between time T21 and T27. The operation of the converting device 100 can be further extended after time T27, and the operation after time T27 is similar to the operation during time T21 to T27. For example, as shown in FIG. 2, the operation of the converting device 100 in the period between T27 and T29 is the same as the operation in the period between T21 and T27.

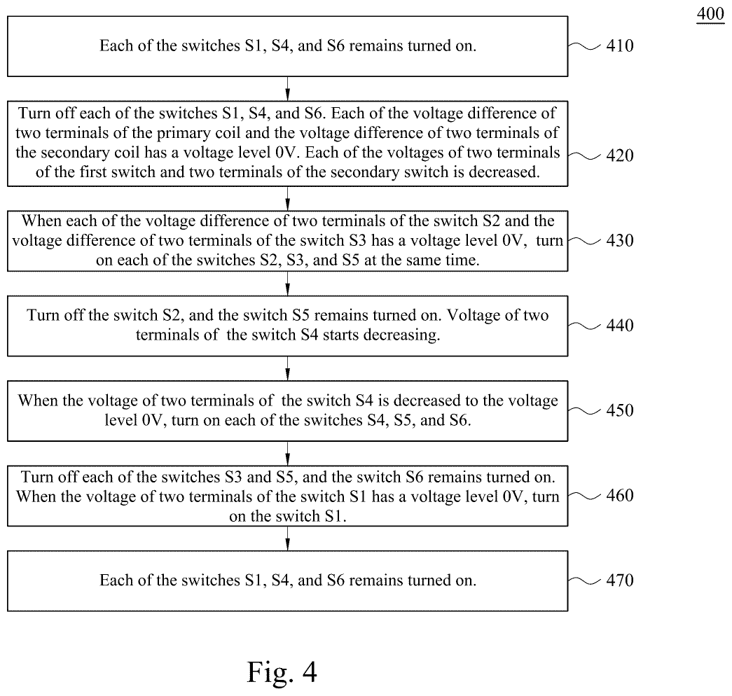

FIG. 4 is a flow chart diagram 400 illustrating the method of controlling a converting device 100 according to some embodiments of the disclosure. As shown in FIG. 4, the flow chart diagram 400 includes operations 410-470.

Referring to FIG. 4 and FIG. 2, the operation 410 corresponds to the period between time T21 and T22 in FIG. 2. The operation 420 corresponds to the period between time T22 and T23. The operation 430 corresponds to the period between time T23 and T24. The operation 440 corresponds to the period between time T24 and T25. The operation 450 corresponds to the period between time T25 and T26. The operation 460 corresponds to the period between time T26 and T27. The operation 470 corresponds to the period between time T27 and T28.

In operation 410, each of the voltage control signals Vg1, Vg4, and Vg6 has the voltage level V1, so that each of the switches S1, S4, and S6 remains turned on. Each of the voltage control signals Vg2, Vg3, and Vg5 has the voltage level V0, so that each of the switches S2, S3, and S5 remains turned off. The converting device 100 continues to operation 420 after operation 410.

In operation 420, each of the voltage control signals Vg1, Vg4, and Vg6 is switched from the voltage level V1 to the voltage level V0. In response to each of the voltage control signals Vg1, Vg4, and Vg6 has the voltage level V0, each of the switches S1, S4, and S6 is turned off. Each of the voltage control signals Vg2, Vg3, and Vg5 has the voltage level V0, so that each of the switches S2, S3, and S5 remains turned off.

At this moment, each of the voltage difference Vp of two terminals of the primary coil Np and the voltage difference Vs of two terminals of the secondary coil Ns is decreased to a voltage level 0V. The converting device 100 continues to operation 430 after operation 420.

In operation 430, when each of the voltage difference Vs2 of two terminals of the switch S2 and the voltage difference Vs3 of two terminals of the switch S3 has a voltage level 0V, each of the voltage control signals Vg2, Vg3, and Vg5 is switched from the voltage level V0 to the voltage level V1. In response to each of the voltage control signals Vg2, Vg3, and Vg5 has the voltage level V0, each of the switches S2, S3, and S5 is turned on. Each of the voltage control signals Vg1, Vg4, and Vg6 has the voltage level V0, so that each of the switches S1, S4, and S6 remains turned off. The converting device 100 continues to operation 440 after operation 430.

In operation 440, the voltage control signal Vg2 is switched from the voltage level V1 to the voltage level V0. In response to the voltage control signal Vg2 has the voltage level V0, the switch S2 is turned off. Each of the voltage control signals Vg1, Vg4, and Vg6 has the voltage level V0, so that each of the switches S1, S4, and S6 remains turned off. each of the voltage control signals Vg3 and Vg5 has the voltage level V1, so that each of the switches S3 and S5 remains turned on.

At this moment, in response to the switch S2 is turned off, the voltage level Vs4 of two terminals of the switch S4 is decreased to a voltage level 0V. the converting device 100 continues to operation 450 after operation 440.

In operation 450, when the voltage level Vs4 of two terminals of the switch S4 has a voltage level 0V, each of the voltage control signals Vg4 and Vg6 is switched from the voltage level V0 to the voltage level V1. In response to each of the voltage control signals Vg4 and Vg6 has the voltage level V1, each of the switches S4 and S6 is turned on. Each of the voltage control signals Vg1 and Vg2 has the voltage level V0, so that each of the switches S1 and S2 remains turned off. Each of the voltage control signals Vg3 and Vg5 has the voltage level V1, so that each of the switches S3 and S5 remains turned on.

At this moment, in response to each of the switches S5 and S6 is turned on at the same time, each of the voltage difference Vp of two terminals of the primary coil Np and the voltage difference Vs of two terminals of the secondary coil Ns is decreased to a voltage level 0V. The converting device 100 continues to operation 460 after operation 450.

In operation 460, each of the voltage control signals Vg3 and Vg5 is switched from the voltage level V1 to the voltage level V0. In response to each of the voltage control signals Vg3 and Vg5 has the voltage level V0, each of the switches S3 and S5 is turned off. Each of the voltage control signals Vg1 and Vg2 has the voltage level V0, so that each of the switches S1 and S2 remains turned off. Each of the voltage control signals Vg4 and Vg6 has the voltage level V1, so that each of the switches S4 and S6 remain turned on.

At this moment, in response to the switch S3 is turned off, the voltage difference Vs1 of two terminals of the switch S1 is decreased to a voltage level 0V. The converting device 100 continues to operation 470 after operation 460.

In operation 470, when the voltage difference Vs1 of two terminals of the switch S1 has a voltage level 0V, the voltage control signal Vg1 is switches from the voltage level V0 to the voltage level V1. In response to the voltage control signal Vg1 has the voltage level V1, the switch S1 is turned on. Each of the voltage control signals Vg2, Vg3, and Vg5 has the voltage level V0, so that each of the switches S2, S3, and S5 remains turned off. Each of the voltage control signals Vg4 and Vg6 has the voltage level V1, so that each of the switches S4 and S6 remains turned on. The converting device 100 has completed a period of operation after operation 470. Wherein FIG. 3A corresponds to a circuit diagram of the converting device 100 after operation 470.

In some embodiments, after the converting device 100 completes operation 470, the converting device 100 continues to operation 410, and repeats the procedure of the operations from operation 410 to operation 470.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method of controlling a converting device, the method comprising:
turning on a first switch coupled to a primary coil and a second switch coupled to the primary coil to generate a primary current flowing through the primary coil;
generating a secondary current flowing through a secondary coil according to the primary current, and supplying power to a load by the secondary current;
when each of the first switch and the second switch is turned off, turning on a third switch coupled to the primary coil and a fourth switch coupled to the primary coil;
when the third switch is turned off, discharging a capacitor of the second switch to the primary coil, and reducing a voltage difference of two terminals of the second switch to a zero voltage level; and
turning on the second switch when the voltage difference of the two terminals of the second switch has the zero voltage level.

2. The method of claim 1, further comprising:
when each of the first switch and the second switch is turned off, discharging the primary coil by each of a capacitor of the third switch and a capacitor of the fourth switch.

3. The method of claim 1, wherein when each of the first switch and the second switch is turned off, each of a voltage difference of two terminals of the third switch and a voltage difference of two terminals of the fourth switch has the zero voltage level.

4. The method of claim 1, further comprising:
when the second switch is turned on, reducing a voltage difference of two terminals of the primary coil and a voltage difference of two terminals of the secondary coil to the zero voltage level.

5. The method of claim 1, further comprising:
when the second switch is turned on, turning on a fifth switch coupled to the secondary coil, so that the secondary current flows through the fifth switch to supply power to the load.

6. The method of claim 4, further comprising:
when each of the voltage difference of two terminals of the primary coil and the voltage difference of two terminals of the secondary coil has the zero voltage level, turning off the fourth switch.

7. The method of claim 6, further comprising:
when the fourth switch is turned off, discharging the primary coil by a capacitor of the first switch.

8. The method of claim 1, further comprising:
when each of the third switch and the fourth switch is turned off, turning off a sixth switch coupled to the secondary coil, so that the secondary current flows through a fifth switch to supply power to the load.

9. The method of claim 7, further comprising:
turning on the first switch when a voltage difference of two terminals of the first switch has the zero voltage level.

10. A converting device, comprising:
a first switch coupled to a primary coil;
a second switch coupled to the primary coil; and
an input power source configured to generate a primary current flowing from the first switch through the primary coil to the second switch,
wherein the primary current is configured to generate a secondary current flowing through a secondary coil, and the secondary current is configured to supply power to a load,
when each of the first switch and the second switch is turned off, turning on a third switch coupled to the primary coil and a fourth switch coupled to the primary coil, and
when each of the first switch and the second switch is turned off, each of a voltage difference of two terminals of the first switch and a voltage difference of two terminals of the second switch is reduced to a zero voltage level.

11. The converting device of claim 10, wherein when the third switch is turned off, discharging the primary coil by a capacitor of the second switch, and a voltage difference of the second switch is reduced to the zero voltage level.

12. The converting device of claim 11, wherein when a voltage difference of the second switch is reduced to the zero voltage level, turning on the second switch.

13. The converting device of claim 12, wherein when the second switch is turned on, each of a voltage of the primary coil and a voltage of the secondary coil is reduced to the zero voltage level.

14. The converting device of claim 12, wherein when the second switch is turned on, turning on a fifth switch coupled to the secondary coil, so that the secondary current flows through the fifth switch to supply power to the load.

15. The converting device of claim 10, wherein when each of the first switch and the second switch is turned off, each of a capacitor of the third switch and a capacitor of the fourth switch is configured to discharge the primary coil.

16. The converting device of claim 15, wherein when each of the first switch and the second switch is turned off, each of a voltage difference of two terminals of the third switch and a voltage difference of two terminals of the fourth switch has the zero voltage level.

17. The converting device of claim 16, wherein when each of the voltage difference of two terminals of the primary coil and the voltage difference of two terminals of the secondary coil has the zero voltage level, turning off the fourth switch.

18. The converting device of claim 17, wherein when the fourth switch is turned off, discharging the primary coil by a capacitor of the first switch.

19. The converting device of claim 10, wherein when each of the third switch and the fourth switch is turned off, turning off a sixth switch coupled to the secondary coil, so that the secondary current flows through a fifth switch to supply power to the load.

20. The converting device of claim 17, wherein turning on the first switch when a voltage difference of two terminals of the first switch has the zero voltage level.
